(19) United States
(12) Patent Application Publication
(10) Pub. No.: US 2026/0330702 A1
(43) Pub. Date: Oct. 22, 2026

(54) IMAGE QUALITY OF A VIRTUAL MEETING USING ARTIFICIAL INTELLIGENCE

(71) Applicant: Google LLC, Mountain View, CA (US)

(72) Inventors: Duc-Hieu Tran, Zurich (CH); Florian Nils Hartmann, Zurich (CH)

(21) Appl. No.: 19/186,317

(22) Filed: Apr. 22, 2025

(51) Int. Cl. G06T 11/00; G06T 3/40; G06T 7/70

(52) U.S. Cl. CPC G06T 11/00; G06T 3/40; G06T 7/70; G06T 2200/24; G06T 2207/10016; G06T 2207/20081; G06T 2207/30196; G06T 2210/12

(57) ABSTRACT

Aspects of the disclosure are directed to improving image quality of a virtual meeting using artificial intelligence. An image depicting at least one participant of the virtual meeting in an environment is obtained during the meeting. The image is captured by a camera component having a first focal length. A target focal length for the image is determined during the meeting based on a position of the participant in the environment. The image and the target focal length are provided as an input to an artificial intelligence (AI) model. One or more outputs of the AI model are obtained, the output(s) including a generated image depicting the participant in the environment as would be captured by another camera component having a second focal length corresponding to the target focal length. The generated image is provided for presentation via one or more client devices associated with the participants during the meeting.

### TECHNICAL FIELD

Aspects and implementations of the present disclosure relate to improving image quality of a virtual meeting using artificial intelligence.

### BACKGROUND

A platform can enable users to connect with other users through a video-based or audio-based virtual meeting (e.g., a conference call). The platform can provide tools that allow multiple client devices to connect over a network and share each other's audio data (e.g., a voice of a user recorded via a microphone of a client device) and/or video data (e.g., a video captured by a camera of a client device, etc.) for efficient communication. The quality and/or settings of a camera collecting video data during a virtual meeting can impact the overall quality of the video feed presented to participants of the conference call, which can impact the overall participant experience.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes obtaining, during a virtual meeting, an image depicting at least one participant of participants of the virtual meeting in an environment. The image is captured by a camera component having a first focal length. The method further includes determining, during the virtual meeting, a target focal length for the image based on a position of the at least one participant in the environment. The method further includes providing, during the virtual meeting, the image and the target focal length as an input to an artificial intelligence (AI) model. The method further includes obtaining, during the virtual meeting, one or more outputs of the AI model, the one or more outputs including a generated image depicting the at least one participant in the environment as would be captured by another camera component having a second focal length corresponding to the target focal length. The method further includes providing, during the virtual meeting, the generated image for presentation via one or more client devices associated with the participants.

In some implementations, the method further includes determining that the position of the at least one participant in the environment has changed. The method further includes determining an updated target focal length for the image based on the changed position. The method further includes providing an additional image depicting the at least one participant in the changed position and the updated target focal length as an additional input to the AI model. The method further includes obtaining one or more additional outputs of the AI model, the one or more additional outputs including an additional generated image depicting the at least one participant in the environment as would be captured by the other camera component having a third focal length corresponding to the updated target focal length. The method further includes providing, during the virtual meeting, the additional generated image for presentation via the one or more client devices.

In some implementations, the method further includes receiving a request for performance of a zoom operation to modify a perspective of the at least one participant from a first zoom factor to a second zoom factor with respect to a field of view of the camera component. The target focal length is further determined based on the first zoom factor and the second zoom factor.

In some implementations, the request for performance of the zoom operation is received responsive to at least one of a user interaction with one or more UI elements of a meeting UI at the one or more client devices, or a detection of an audio signal at a region of the environment including the at least one participant.

In some implementations, the method further includes obtaining feature data representing one or more features associated with a region of the image that depicts the at least one participant. The method further includes providing the feature data as an additional input to the AI model. The generated image depicting the at least one participant includes the one or more features represented by the provided feature data.

In some implementations, obtaining the feature data includes performing one or more bounding box operations with respect to the image. An output of the one or more bounding box operations includes bounding box data representing the region of the image that depicts the at least one participant. The method further includes extracting the one or more features from the region of the image represented by the bounding box data.

In some implementations, obtaining the feature data includes receiving the feature data from a component of a cloud computing platform associated with one or more additional functionalities with respect to the virtual meeting.

In some implementations, the method further includes receiving at least a portion of the AI model from one or more computing devices associated with a cloud computing platform. The method further includes storing the at least the portion of the AI model at a memory of a local computing device associated with the environment. The image and the target focal length is provided as the input to the AI model stored at the memory of the local computing device.

In some implementations, the image includes an initial video frame of a sequence of video frames captured by the camera component during the virtual meeting. The method further includes obtaining a subsequent video frame of the sequence of video frames, the subsequent video frame depicting the at least one participant in the environment. The method further includes providing the subsequent video frame, the target focal length, and optionally, the generated image associated with the initial video frame as an additional input to the AI model. The method further includes obtaining one or more additional outputs of the AI model, the one or more additional outputs including an additional generated image depicting the at least one participant as captured by the other camera component having the second focal length corresponding to the target focal length and in view of the generated image associated with the initial video frame. The method further includes providing, during the virtual meeting, the generated additional output image for presentation via the one or more client devices.

In some implementations, the AI model is a diffusion model.

In some implementations, the AI model is trained using a training data set including a training input including an image depicting a multi-dimensional representation of an environment and an indication of a training focal length associated with the image. The target output may include an enhanced image depicting the multi-dimensional representation of the environment and an indication of a training target focal length associated with the enhanced image.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example image improvement engine, in accordance with implementations of the present disclosure.

FIG. 3 depicts a flow diagram of an example method for improving image quality of a virtual meeting using artificial intelligence (AI), in accordance with implementations of the present disclosure.

FIG. 4 is a block diagram of example AI model(s) and engines associated with improving image quality of a virtual meeting, in accordance with implementations of the present disclosure.

FIGS. 5A-5C illustrate example user interfaces (UIs), in accordance with implementations of the present disclosure.

FIG. 6 illustrates an example predictive system, in accordance with implementations of the present disclosure.

FIG. 7 is a block diagram of an example method for training an AI model to generate an enhanced image, in accordance with implementations of the present disclosure.

FIG. 8 is a block diagram illustrating an exemplary computer system, in accordance with implementations of the present disclosure.

### DETAILED DESCRIPTION OF THE DRAWINGS

Aspects of the present disclosure relate to improving image quality of a virtual meeting using artificial intelligence (AI). A platform can enable users to connect with other users through a video or audio-based virtual meeting (e.g., a conference call, etc.). In some instances, a participant may join a virtual meeting via a personal device, such as a laptop, a smartphone, a tablet, etc. The field of view of the participant accessing the virtual meeting via the personal device may focus on the participant's face and upper body, ensuring clear and direct visual communication. In other instances, one or more participants may join a virtual meeting via a shared meeting room. Given that multiple participants may be present in the shared meeting room, the field of view of the shared meeting room may be wider, in order to accommodate a wider horizontal space to ensure that everyone (or at least most people) in the shared meeting room are visible.

The focal length of a camera component refers to the distance between a lens of the camera component and an image sensor of the camera component when a subject is in focus. A camera component having a short focal length (e.g., such as 35 millimeters (mm) and below, or less than 24 mm, e.g., 18 mm) can provide a wide field of view, allowing the camera component to capture more of a scene or an environment. A camera component having a long focal length (e.g., such as 24 mm and above, or 70 mm and above, e.g., 85 mm) can provide a narrower field of view, which can zoom in on a smaller area and/or make distant objects appear closer. Although long and short focal lengths are generally understood, in some examples, a long focal length of a camera can be a focal length longer than a diagonal measure of an image sensor of the camera, whereas a short focal length can be a focal length smaller than the diagonal measure of the image sensor of the camera. In light of the above, shared meeting rooms often include camera components having a short focal length, which enables the capture of the wider horizontal space of the meeting room.

While camera components having a short focal length are able to capture a wider horizontal space of a recorded environment, the objects in the environment may appear distorted based on their position or location within the environment. For example, if a camera component is located at one end of a table in a shared meeting room and multiple participants sit around the table facing the camera component, the participants that are located closer to the camera component will appear to be larger than the participants that are located farther away from the camera component (e.g., at the opposite end of the table). Addressing these image distortions, improving the quality of the images and/or making the images appear more natural can be beneficial. In some instances, depending on the position or location of a participant in a shared meeting room, other participants of the virtual meeting (e.g., that are not present in the meeting room) may have difficulty identifying or recognizing the participants that are located farther away from the camera component(s), which can be distracting to such participants. Some participants may interrupt a current discussion of the meeting to ask about the identity of the indecipherable participants in the shared meeting room, which can disrupt the flow of the discussion and therefore cause the virtual meeting to take a longer period of time. By extending the duration of the virtual meeting, additional computing resources are consumed (e.g., by client devices of participants accessing the meeting, by a platform that supports the meeting, by the overall system, etc.), which can increase the overall latency and decrease the overall efficiency of the system. Given the size and setup of the shared meeting room, it may be impractical or otherwise impossible to include a camera component having a long local length.

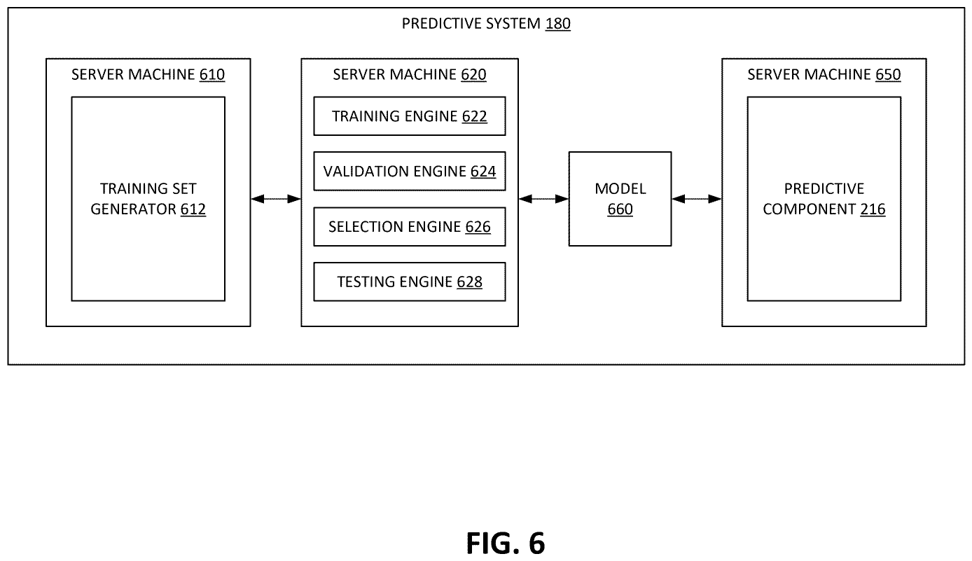

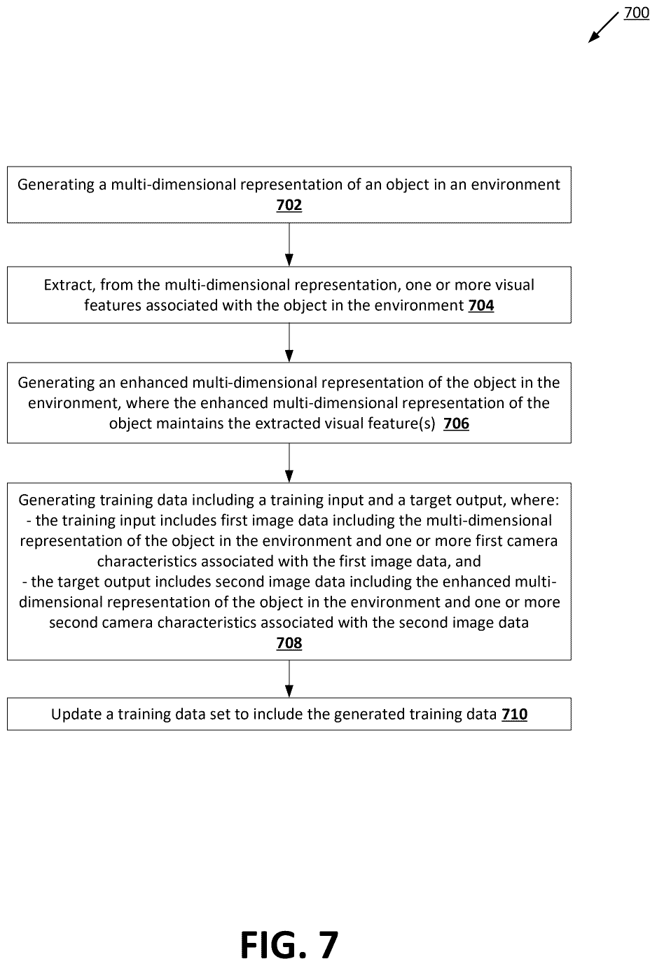

Implementations of the present disclosure address the above and other deficiencies by providing methods and systems for improving image quality of a virtual meeting using artificial intelligence (AI). As described herein, an AI model can be trained to generate an enhanced image of a virtual meeting based on an initial image of the virtual meeting and target characteristics of the enhanced image. In some embodiments, the target characteristics can correspond to images captured by a camera component having a long focal length (e.g., narrow field of view, a compressed perspective, a shallow depth of field, less distortion, etc.), where the initial image may have characteristics that correspond to images captured by a camera component having a short focal length (e.g., wide field of view, an exaggerated perspective, a deep depth of field, more distortion, etc.). In some embodiments, the enhanced image can preserve features associated with participants or other objects depicted by the initial image. The AI model may be trained using image data depicting objects in a real-world environment and/or based on a multi-dimensional (e.g., a three-dimensional (3D)) representation of simulated objects in a simulated environment. Some details regarding training the AI model are provided herein with respect to FIGS. 6-7.

During a virtual meeting, a camera component of a shared meeting room can generate image data (e.g., video frames) depicting at least one virtual meeting participant in the meeting room. The camera component can have a first focal length (e.g., a short focal length). In some embodiments, the system can determine a position of the virtual meeting participant in the virtual meeting room and can determine a target focal length for the image based on the position of the participant. The system can provide the image and the target focal length for the image as an input to the AI model and obtain one or more outputs of the AI model. The output(s) of the AI model can include a generated image depicting the virtual meeting participant in the environment as captured by a camera component having a second focal length (e.g., a long focal length) corresponding to the target focal length. The system can provide the generated image for presentation via one or more client devices associated with the virtual meeting participant and/or other participants of the virtual meeting (e.g., participants that are not located in the shared meeting room).

In some embodiments, prior to obtaining the generated image, the system can perform one or more bounding box operations to obtain bounding box data representing a region of the image that depicts the virtual meeting participant. The system can extract visual features (e.g., facial features, a pose or orientation, etc.) of the virtual meeting participant from the region represented by the bounding box data and can provide the extracted visual features as an additional input to the AI model. The generated image can retain the visual features of the virtual meeting participant extracted from the image captured by the camera component in the shared meeting room, in some embodiments.

In some embodiments, operations or tasks of the present disclosure can be performed at a local computing system of the shared meeting room and/or at a computing system of a cloud computing environment. For example, the AI model may be trained, as described in further detail below, at a computing system of a cloud computing environment and stored or otherwise installed at a local computing system of the shared meeting room. One or more processors of the local computing system can provide the image(s) captured by the camera component as an input to the AI model at the local computing system and obtain the generated image(s) having the target characteristics from the output(s) of the AI model. The processor(s) of the local computing system can transmit (e.g., via a network) the generated image(s) to a platform of the cloud computing environment and the platform can stream the generated image(s) to other client devices of other participants of the virtual meeting (e.g., that are not located in the shared meeting room), in some embodiments.

Aspects of the present disclosure provide techniques for improving image quality of a virtual meeting using artificial intelligence. These techniques enable a platform to obtain enhanced images (e.g., video frames) having characteristics associated with images that are generated by a camera component having a long focal length based on initial images captured by a camera component having a short focal length. The enhanced images as if they were taken by a camera component having a longer focal length can have less distortion, be of higher quality and/or appear more natural, but without having to provide a camera component having a long focal length. Accordingly, the platform can provide participants of the virtual meeting with access to the enhanced images, which can provide a clear picture of the environment and/or the participants in the shared meeting room. Thus, disruptions to the flow of the virtual meeting are minimized, which shortens the overall length of the virtual meeting. As the overall length of the virtual meeting is shortened, fewer computing resources (e.g., processing cycles, memory space, network bandwidth) are consumed by the platform and/or client devices of the virtual meeting participants, and additional computing resources are made available for other processes, therefore increasing the overall efficiency and decreasing the overall latency of the system.

It should be noted that although some embodiments and examples of the present disclosure are provided with respect to images generated by a camera component of a shared meeting room, such embodiments and examples can be applied to obtaining enhanced images based on images captured by any type of camera component in any environment. For example, as will be seen below, embodiments and examples of the present disclosure can be applied to obtaining enhanced images based on initial images (e.g., a video feed) captured by a personal device of a virtual meeting participant (e.g., a cellular phone, a tablet, etc.) in a real-world environment, such as an outdoors environment, etc.

Implementations described herein may involve the collection of data describing a user and/or activities of a user. To address the privacy of users, various techniques may be implemented. In one implementation, the collection of such data occurs only after the user provides consent. In some implementations, a user may be presented with a prompt to explicitly allow the collection of this data. In the instance where the user consents to the use of such data, the data may be used for the described functionalities.

Prior to the system enabling collection of user information (e.g., facial features), a user may be provided with controls allowing the user to make an election as to both if and when the system may enable such collection. For in-room participants, clear and conspicuous information regarding the data collection may be provided before their participation. This information may include the fact that the system processes video to create facial embeddings for identification, and that full photographic images may not be stored. The purpose of this processing may be to provide individual recognition of in-room participants to enhance the virtual meeting experience. Details regarding how facial embeddings and associated identifiers may be used within the meeting context may also be provided.

In some implementations, users may be informed of the security measures in place to protect facial embeddings, such as encryption prior to being stored. Information regarding how long facial embeddings may be retained and the procedures for their removal may also be provided. Users may be informed of their options regarding their biometric data. Contact information for privacy-related questions may be made available. Methods of providing such information may include in-room displays or a companion application for in-room participants, and the platform user interface for remote participants.

In some implementations, the system may obtain an affirmative indication from in-room participants prior to facial identification. For instance, in the instance where a user consents to the association of a detected facial region with their identifier, the system may record this association. For automatic identification based on facial features, prior affirmative indication may be obtained for the enrollment and storage of these features. Alternative methods for in-room participants to indicate their presence without using facial recognition may be available. Participants may be informed of their ability to withdraw their consent and may be provided with mechanisms to do so, such as leaving camera view or using a user interface control. The consequences of withdrawing consent may be clearly communicated.

Users may have the ability to review and potentially modify their stored facial feature data. Users may also have the ability to remove their stored facial feature data. The ability to disable automatic identification within meeting or profile settings may be provided to users. If a misidentification occurs, mechanisms for a user to correct this may be available.

In some implementations, the system may store only facial embeddings derived from photos and may not retain the full photographic images. Client devices may, in some implementations, derive facial embeddings locally before sending them to a server. Biometric data processed for identification and association during a meeting may be temporary. Data describing facial features may be retained only for the minimum duration required for meeting functionality and may be removed shortly after the meeting concludes unless an affirmative indication is provided for longer retention to potentially improve future accuracy. The use of facial feature data may be limited to the purpose of identifying in-room participants within virtual meetings. Implementations may employ advanced security protocols, including multi-layered encryption and strict access controls, to ensure the confidentiality and integrity of stored facial embeddings against unauthorized access and potential breaches.

Data describing facial features may be treated in one or more ways before it is stored or used, so that personally identifiable information is removed. For example, a user's identity may be treated so that no personally identifiable information can be determined for the user. Access to stored facial feature data may be controlled to limit which components and personnel can access it.

The system may be designed to align with privacy considerations. Where technically viable, processing of facial features for matching may occur locally on the client device against a downloaded set of meeting participant features to reduce server-side processing. Measures to reduce the risk of unintentionally capturing and processing biometric data of individuals not participating in the meeting may be implemented. Privacy considerations may be addressed in the design of application programming interfaces (APIs), such as not retaining detailed data in logs and enforcing strong security for data retrieval. A description of the retention periods and data removal procedures for all collected and processed data related to this system may be documented.

Workspace administrators may be provided with controls to manage implementations within their domain, including the ability to enable or disable it for specific units or users and potentially remove enrollment data. Features for reviewing the usage of automatic identification may be implemented to support accountability.

It should be noted that although aspects of the present disclosure are described with reference to a conference room, they should not be so limited, and can be used in any other space or location allowing a group setting for participating users.

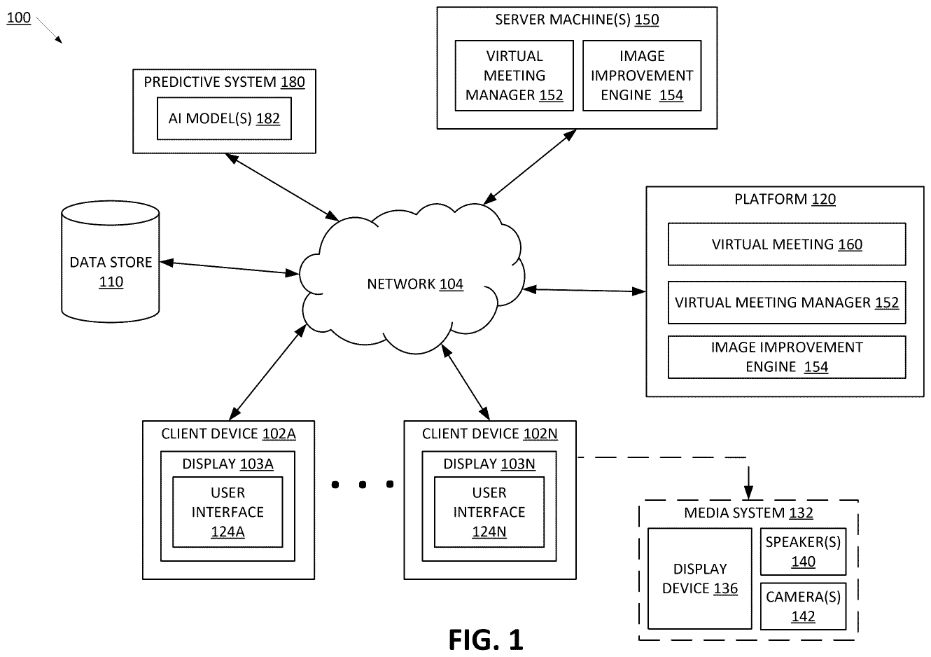

FIG. 1 illustrates an example system architecture 100, in accordance with implementations of the present disclosure. The system architecture 100 (also referred to as “system” herein) includes client devices 102A-N (collectively and individually referred to as client device 102 herein), a data store 110, a platform 120, and/or one or more server machines 150, each connected to a network 104. In implementations, network 104 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more video streams, audio streams, and/or meeting transcripts that can be used to generate meeting resources (e.g., at predetermined time intervals) and/or to generate the electronic documents (e.g., at a time after the end of the virtual meeting). Data store 110 can be hosted by one or more storage devices, such as main memory, magnetic or optical storage-based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 104.

Platform 120 can enable users of client devices 102A-N to connect with each other via a virtual meeting (e.g., virtual meeting 160). The virtual meeting 160 can be a video-based virtual meeting, which includes a meeting during which a client device 102 connected to platform 120 captures and transmits video streams (e.g., collected by a camera of a client device 102) and/or audio streams (e.g., collected by a microphone of the client device 102) to other client devices 102 connected to platform 120. The video streams can, in some embodiments, depict a user or group of users that are participating in the virtual meeting 160 (also referred to as participants). The audio streams can include, in some embodiments, an audio recording of audio provided by the user or group of users during the virtual meeting 160. In additional or alternative embodiments, the virtual meeting 160 can bean audio-based virtual meeting, which includes a meeting during which a client device 102 captures and transmits audio streams (e.g., without generating and/or transmitting image streams) to other client devices 102 connected to platform 120. In some instances, a virtual meeting can include or otherwise be referred to as a conference call. In such instances, a video-based virtual meeting can include or otherwise be referred to as a video-based conference call and an audio-based virtual meeting can include or otherwise be referred to as an audio-based conference call.

The client devices 102A-N can each include computing devices such as personal computers (PCs), laptops, mobile phones, smart phones, tablet computers, netbook computers, network-connected televisions, etc. In some implementations, client devices 102A-N may also be referred to as “user devices.” A client device 102 can include an audiovisual component that can generate audio and video streams to be transmitted to conference platform 120. In some implementations, the audiovisual component can include one or more devices (e.g., a microphone, etc.) that capture an audio streams representing audio provided by the user. The audiovisual component can generate audio data (e.g., an audio file) based on the captured audio stream. In some embodiments, the audiovisual component can additionally or alternatively include one or more devices (e.g., a speaker) that output data to a user associated with a particular client device 102. In some embodiments, the audiovisual component can additionally or alternatively include a video capture device (e.g., a camera) to capture videos streams and generate video data (e.g., a video file) based on the captured video streams.

In some embodiments, one or more client devices 102 can be devices of a physical conference room or a meeting room. Such client devices 102 can be included at or otherwise coupled to a media system 132 that includes one or more display devices 136, one or more speakers 140 and/or one or more cameras 142. A display device 136 can be, or otherwise include, a smart display or a non-smart display (e.g., a display that is not itself configured to connect to platform 120 or other components of system 100 via network 104). Users that are physically present in the conference room or the meeting room can use a media system 132 rather than their own client devices 102 to participate in a virtual meeting, which may include other remote participants. For example, participants in the conference room or meeting room that participate in the virtual meeting may use display device 136 to share a slide presentation with, or watch a slide presentation of, other participants that are accessing the virtual meeting remotely. Sound and/or camera control can similarly be performed. As described above, a client device 102 connected to the media system 132 can generate media streams (e.g., audio and video streams) to be transmitted to platform 120 (e.g., using one or more microphones (not shown), speaker(s) 140 and/or camera(s) 142).

Client devices 102A-N can each include a content viewer, in some embodiments. In some implementations, a content viewer can be an application that provides a user interface (UI) (sometimes referred to as a graphical user interface (GUI)) for users to access the virtual meeting 160 hosted by platform 120. The content viewer can be included in a web browser and/or a client application (e.g., a mobile application, a desktop application, etc.). In one or more examples, a user of client device 102A can join and participate in the virtual meeting 160 via UI 124A presented via display 103A via the web browser and/or client application. A user can also present or otherwise share a document to other participants of the virtual meeting 160 via each of UIs 124A-124N. Each of UIs 124A-124N can include multiple regions that enable presentation of visual items corresponding to video streams of client devices 102A-102N provided to platform 120 during the virtual meeting 160.

In some embodiments, platform 120 can include a virtual meeting manager 152. Virtual meeting manager 152 can be configured to manage the virtual meeting 160 between two or more users of platform 120. In some embodiments, the virtual meeting manager 152 can provide the UI 124 to each of client devices 102 to enable users to watch and listen to each other during a video conference. The virtual meeting manager 152 can also collect and provide data associated with the virtual meeting 160 to each participant of the virtual meeting 160. For example, the virtual meeting manager 152 can provide documents that are associated with the virtual meeting 160 to one or more participants of the virtual meeting 160.

Platform 120 can additionally or alternatively include a transcription engine (not shown) that generates a transcript based on a discussion between participants of a virtual meeting 160. An engine, as described herein, refers to a component of a system (e.g., system 100) that powers and drives one or more functionalities of the system. An engine can be a software engine that includes or otherwise corresponds to a core program or set of operations that drive specific functionality within a system or application and/or a hardware engine that includes or otherwise corresponds to a physical component designed to perform specialized tasks. In some embodiments, the transcription engine can be an engine that is designed or otherwise configured to generate a transcript reflecting verbal statements and/or textual statements provided by participants during a virtual meeting 160.

In some embodiments, the transcription engine can generate a transcript by translating audio signal(s) collected by client device(s) 102 into a textual representation of the verbal statements provided during the discussion of the virtual meeting 160. For example, the transcription engine can perform one or more audio input processing operations to refine an audio signal (e.g., remove background noise, normalize volume, enhance speech clarity, etc.). The transcription engine may then provide the refined audio signal as an input to one or more AI models that are trained to perform speech recognition operations (e.g., analyze audio signals to recognize and interpret human speech) and/or language modeling operations (e.g., predict a likely sequence of words or phrases based on grammar, context, and known vocabulary). The transcription engine can obtain one or more outputs of the AI models, which can include a textual representation of one or more verbal statements included in the audio signal.

As indicated above, a client device 102 can include or be otherwise connected to an audiovisual component that can generate video streams including video data representing one or more participants of virtual meeting 160. The audiovisual component can include a camera component (e.g., camera(s) 142) that capture image data (e.g., video frames) during virtual meeting 160 that is included in the video stream(s) transmitted by a client device 102 to platform 120 and/or other client devices 102 of system 100. In some embodiments, the camera component of or connected to client device 102 can have a short focal length (e.g., a focal length between approximately 12 mm and approximately 30 mm). Images generated by such camera component may have a wide field of view (e.g., capturing a broad representation of a scene or environment), an exaggerated perspective (e.g., objects located closer to the camera component in the scene or environment may appear larger than objects located farther from the camera component), a deep depth of field (e.g., a large portion of the scene stays in focus, from foreground to background), and/or distortion (e.g., straight lines at or around an edge of the camera component's field of view appears curved, features of the objects of the scene or environment appear stretched, etc.). In some embodiments, such camera component can be included or otherwise located at a physical conference room or meeting room of which one or more participants of virtual meeting 160 are located. In other or similar embodiments, such camera component can be included at or otherwise connected to a personal device (e.g., a cellular phone, a tablet, a laptop computer, etc.) of a participant of virtual meeting 160.

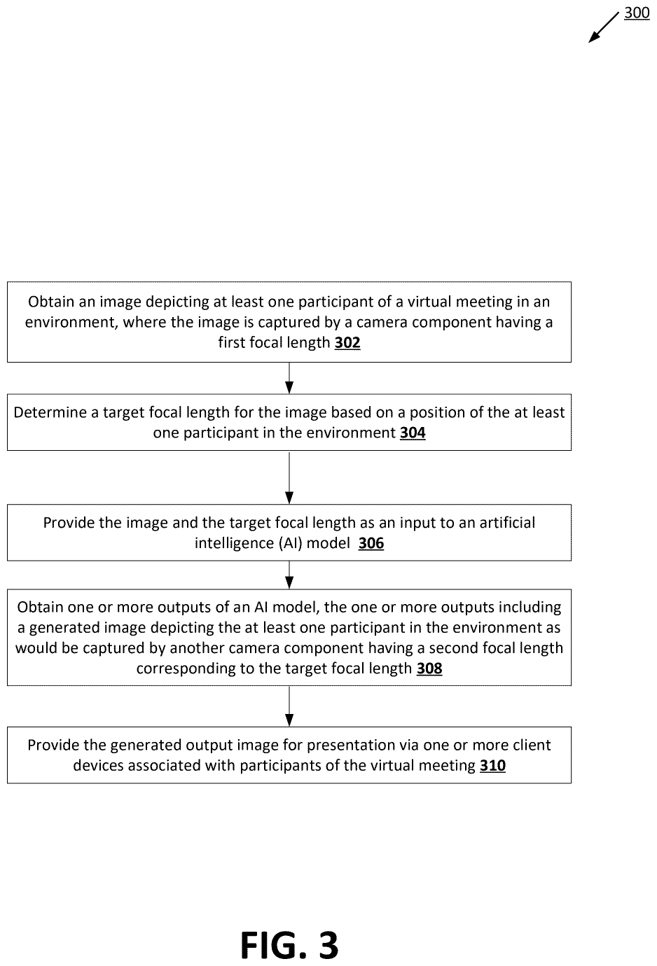

As illustrated by FIG. 3, platform 120 can include an image improvement engine 154, which obtains enhanced images based on initial images captured by such camera component(s) described herein. For example, image improvement engine 154 can determine a target focal length (e.g., a long focal length) for an image depicting an object (e.g., a virtual meeting participant) in an environment (e.g., a conference room or a shared meeting room) and can provide initial images depicting the object and the target focal length as an input to one or more AI model(s) 182. A long focal length may include or otherwise correspond to a focal length of or exceeding 50 mm. At least one of the AI model(s) 182 may be trained to generate an enhanced image having characteristics of an image captured by a camera component having the target focal length. A camera component having a long focal length (e.g., at or around 24 mm or longer) can capture images that have a narrow field of view (e.g., represent a small, zoomed-in portion of the scene), a compressed perspective (e.g., represent objects located in a background of the image appear closer to the foreground, flattening the sense of depth), a shallow field of depth (e.g., background objects appear blurred while subjects appear focused), and/or less distortion (e.g., features of the objects or subjects are represented according to natural proportions, etc.). Image improvement engine 154 can obtain one or more enhanced images from an output of the AI model 182 and can provide the enhanced image for presentation to participants of the virtual meeting 160 (e.g., via display 132 and/or via display device 136). Further details regarding image improvement engine 154 and obtaining enhanced images of virtual meeting participants in a virtual meeting environment are provided herein.

It should be noted that although FIG. 1 illustrates the virtual meeting manager 152 and/or image improvement engine 154 as part of platform 120, in additional or alternative embodiments, virtual meeting manager 152 and/or image improvement engine 154 can reside on one or more server machines that are remote from platform 120 (e.g., server machine(s) 150). It should be noted that in some other implementations, the functions of platform 120, server machine(s) 150 and/or predictive system 180 can be provided by more or a fewer number of machines. For example, in some implementations, components and/or modules of platform 120, server machine(s) 150 and/or predictive system 180 may be integrated into a single machine, while in other implementations components and/or modules of any of platform 120, server machine(s) 150 and/or predictive system 180 may be integrated into multiple machines. In addition, in some implementations, components and/or modules of server machine(s) 150 and/or predictive system 180 may be integrated into platform 120.

In general, functions described in implementations as being performed by platform 120, server machine(s) 150, and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces.

Although implementations of the disclosure are discussed in terms of platform 120 and users of platform 120 accessing the virtual meeting 160 hosted by platform 120, implementations of the disclosure are not limited to conference platforms and can be extended to any type of virtual meeting.

In implementations of the disclosure, a “user” can be represented as a single individual. However, other implementations of the disclosure can describe a “user” as an entity controlled by a set of users and/or an automated source. For example, a set of individual users federated as a community in a social network can be considered a “user.” In another example, an automated consumer can be an automated ingestion pipeline of platform 120.

In situations in which the systems discussed here collect personal information about users, or can make use of personal information, the users can be provided with an opportunity to control whether the platform 120, virtual meeting manager 152 and/or image improvement engine 154 collects user information (e.g., information about a user's social network, social actions or activities, profession, a user's preferences, or a user's current location), or to control whether or how to receive content from the virtual meeting platform 120 or the virtual meeting manager 152 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 120 or the virtual meeting manager 152.

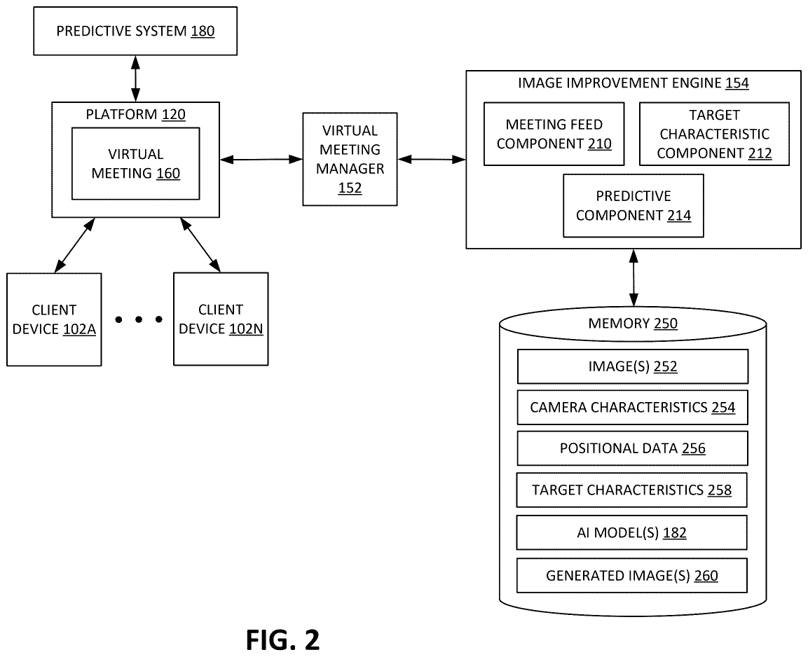

FIG. 2 is a block diagram of an example image improvement engine 154, in accordance with implementations of the present disclosure. As described above, platform 120 can provide users with access to tools and functionalities associated with a virtual meeting 160. For example, a user of client device 102A can participate in a virtual meeting 160 with other users (e.g., of client devices 102B-N) via one or more tools or functionalities provided by platform 120). A camera component (e.g., of or connected to a client device 102 and/or camera(s) 142) can capture or otherwise generate an image (e.g., a video frame) depicting a participant of virtual meeting 160 and/or an environment including the participant, in some embodiments. In some embodiments, the camera component can have a short focal length and therefore the captured image (referred to herein as the initial image) can have a first set of characteristics (e.g., wide field of view, exaggerated perspective, deep depth of field, distortion, etc.), as described above. Image improvement engine 154 can obtain an image generated based on the initial image, where the generated image depicts the participant and/or the environment including the participant and has a second set of characteristics (e.g., narrow field of view, condensed perspective, shallow depth of field, no or less distortion, etc.) associated with images captured by camera components having a target focal length (e.g., a long focal length). The second set of characteristics are also referred to herein as target characteristics, in some embodiments.

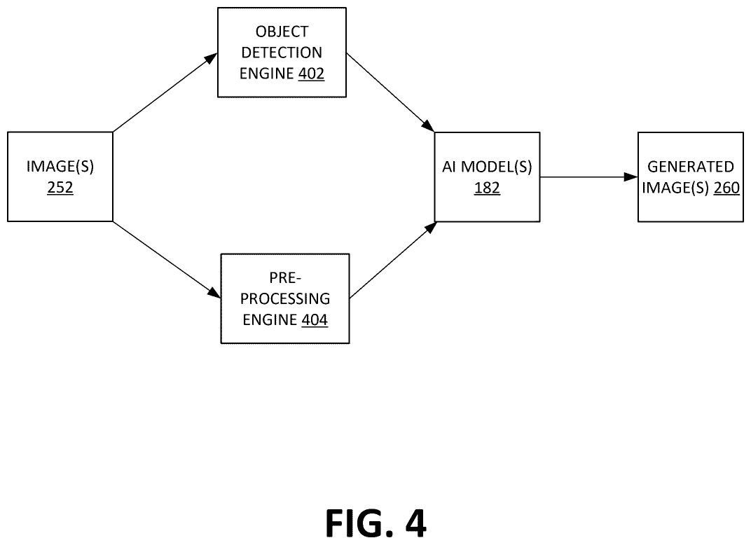

As illustrated by FIG. 2, image improvement engine 154 can include a meeting feed component 210, a target characteristic component 212, and/or a predictive component 214. Image improvement engine 154, virtual meeting manager 152, and/or platform 120 can be connected to a memory 250 (e.g., via network 104, via a bus, etc.). Memory 250 can include one or more portions of data store 110, in some embodiments. In other or similar embodiments, memory 250 can include or correspond to any memory of any component of system 100 and/or otherwise accessible to a component of system 100. Details regarding image improvement engine 154 are provided herein with respect to FIGS. 2-4.

FIG. 3 depicts a flow diagram of an example method 300 for improving image quality of a virtual meeting using artificial intelligence (AI), in accordance with implementations of the present disclosure. Method 300 can be performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1 In some embodiments, some or all of the operations of method 300 can be performed by image improvement engine 154.

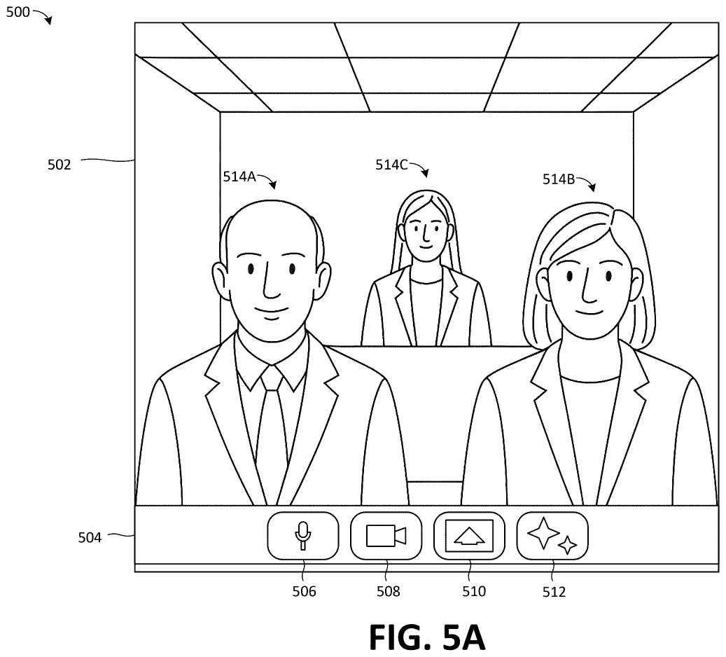

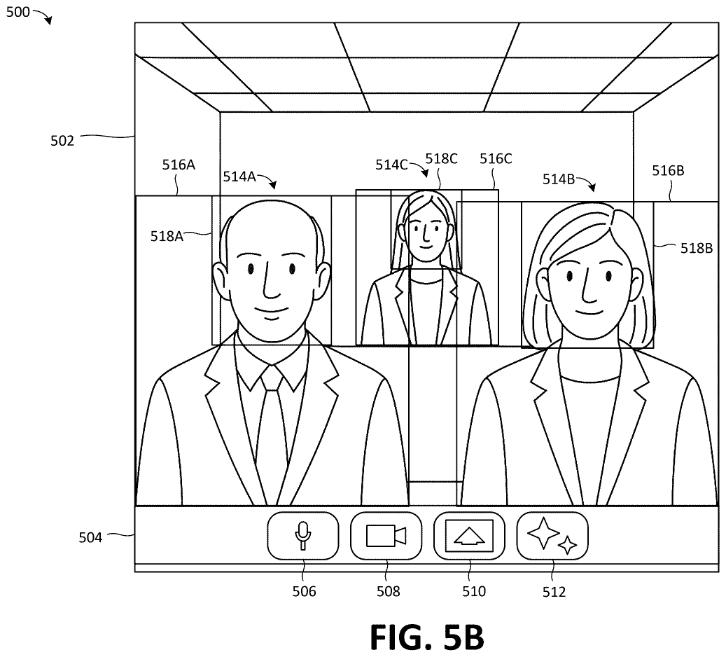

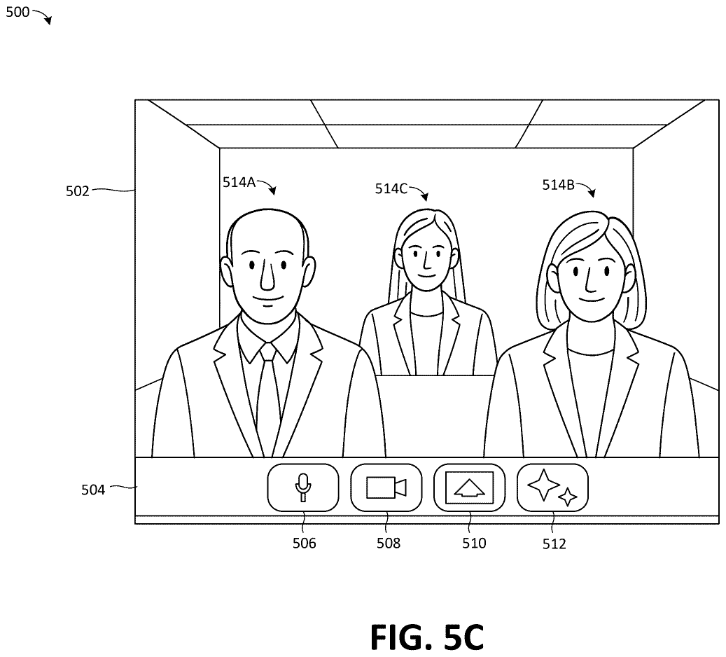

At block 302, processing logic obtains an image depicting at least one participant in a virtual meeting environment. The image 252 is captured by a camera component having a first focal length. As described above, a camera component having a first focal length (e.g., a short focal length) can capture a video feed depicting one or more participants of a virtual meeting 160. The video feed can include a sequence of one or more images 252 (e.g., video frames) that depict the participant(s) in an environment (e.g., a shared meeting room environment, etc.) based on the perspective of the camera component, relative to the participant(s) in the environment. FIG. 5A illustrates an example virtual meeting UI 500 presented during a virtual meeting 160 via client device(s) 102, in accordance with implementations of the present disclosure. As illustrated by FIG. 5A, the UI 500 can include one or more regions 502 corresponding to a visual item of the virtual meeting 160, such as a video stream provided by a client device 102 of a participant of the virtual meeting 160. The virtual meeting UI 500 can additionally or alternatively include a tool bar 504 that includes one or more UI elements associated with virtual meeting operations. For example, as seen in FIG. 5A, the tool bar 504 includes an audio control element 506 (e.g., that enables a participant to mute and unmute their audio stream), a camera control element 508 (e.g., that enables a participant to mute and unmute their video stream), and/or a screen share element 510 (e.g., that enables a participant to initiate a screen sharing operation to share a view of a client device 102 with other participants of the virtual meeting 160). In some embodiments, the tool bar 504 may include one or more UI elements 512 that enable a participant to initiate an automated meeting resource functionality (e.g., to initiate automatic note taking, automatic document retrieval, etc.).

As indicated above, region(s) 502 of UI 500 can include a visual item including an image 252 (e.g., a video frame) of a sequence of images (e.g., a sequence of video frames) captured by a camera component, as described above. As illustrated by FIG. 5A, the image 252 depicts three virtual meeting participants 514 (e.g., participant 514A, participant 514B, participant 514C) within a shared meeting room environment. The camera component that captured the image 252 may have a short focal length, which provides a wide field of view of the shared meeting room environment, as described herein. In the example illustrated by FIG. 5A, participant 514A and/or participant 514B may be located at one end of a table of the shared meeting room that is closest to the camera component that is capturing the image 252. Additionally or alternatively, participant 514C may be located at another end of the table that is farthest from the camera component. Accordingly, the image 252 may depict participant 514A and/or participant 514B as larger than participant 514C.

As described above, a client device 102 can receive the image 252 (e.g., the image of UI 500) from a camera component and can transmit the received image to platform 120 (e.g., via network 104, via a bus, etc.). Meeting feed component 210 of image improvement engine 154 may receive the image 252 and, in some embodiments, can store the image 252 at memory 250. In some embodiments, meeting feed component 210 may receive image 252 from client device 102 via a sequence of video frames continuously transmitted to platform 120 from client device 102 (e.g., during virtual meeting 160). Meeting feed component 210 can extract image 252 from the sequence of video frames, in some embodiments.

In some embodiments, meeting feed component 210 (or another component of image improvement engine 154 or platform 120) may obtain a set of characteristics 254 associated with the camera component that captured or otherwise generated image(s) 252. The set of characteristics 254 can include or otherwise indicate a focal length of the camera component. In some embodiments, a developer or operator of platform 120 and/or system 100 can provide the focal length of the camera component. In other or similar embodiments, meeting feed component 210 can determine the focal length based on one or more of images 252 captured by the camera component. For example, the camera component can capture one or more images during an initialization period (e.g., prior to virtual meeting 160) and/or during an initial time period of a virtual meeting 160. Meeting feed component 210 can determine a size of an object included in the environment (e.g., the length of the table) and/or a distance of an object or a portion of an object from the camera component in the environment. In some embodiments, the developer or operator of platform 120 and/or system 100 can provide the size and/or distance or meeting feed component 210 can estimate or otherwise predict the size or distance of the object (e.g., using AI-based techniques or physical modeling techniques). Meeting feed component 210 can determine a size of the object as depicted by the captured images 252 based on an output of one or more bounding box operations described below. In some embodiments, meeting feed component 210 can calculate the focal length of the camera component based on the following equation:

$$f = \frac{P \cdot D}{S}$$

where f is the focal length (e.g., in pixels), P is the size of the object depicted by image 252 (e.g., in pixels), D is the distance from the camera component to the object, and S is the real-world size of the object. Meeting feed component 210 may determine the first focal length according to other techniques, such as a Structure from Motion technique (e.g., estimating the focal length based on multiple images 252 of the same scene from different viewpoints), vanishing points/scene geometry techniques (e.g., identifying vanishing points from parallel lines depicted by the image 252 and estimating the focal length based on geometric constraints associated with the parallel lines), and so forth.

At block 304, processing logic determines a target focal length based on a position of the at least one participant in the environment. In some embodiments, a developer or operator of platform 120 and/or system 100 can provide the target focal length to platform 120. The target focal length can be provided based on or in view of a size of the shared meeting room and/or a position or a table or chairs of the shared meeting room, in an illustrative example. In other or similar embodiments, target characteristic component 212 can obtain positional data 256 for each object (e.g., each participant 514) in the environment depicted by image 252. The positional data 256 can include, in some embodiments, bounding box data that indicates a region of the image 252 that depicts a respective participant 514 and/or a size or position of the participant 514 at the region. In some embodiments, the positional data 256 can additionally or alternatively include a mapping between bounding box data for a respective participant 514 and a coordinate for a region of the real-world environment (e.g., the shared meeting room) where the participant 514 is located.

FIG. 5B illustrates example bounding box data obtained for each participant 514 depicted by image 252. In some embodiments, target characteristic component 212 can provide image 252 as an input to an object detection engine 402 (e.g., of or otherwise accessible to platform 120 or system 100) that is configured to perform one or more bounding box operations with respect to a given image. The bounding box operations involve reading a given image as a matrix of pixels, providing the matrix of pixels as an input to an AI model (e.g., an object detection model) that is trained to detect objects, and obtaining one or more outputs of the AI model, which includes coordinates for regions of the given image that are likely to include an object. In some embodiments, the output(s) of the object detection model can include an indication of a class of an object, a set of bounding box coordinates, and a level of confidence that the region of the given image indicated by the bounding box coordinates corresponds to the indicated class. In some embodiments, object detection engine 402 can provide the output(s) of the object detection model to target characteristic component 212 and target characteristic component 212 can determine whether a level of confidence that a region of image 252 (e.g., as indicated by the bounding box coordinates) depicts a participant 514 of virtual meeting 160 satisfies one or more confidence criteria (e.g., exceeds a threshold level of confidence, is larger than levels of confidence for other regions of image 252, etc.). Upon determining that a region of image 252 has a level of confidence that satisfies the confidence criteria, target characteristic component 212 can update positional data 256 to include the bounding box data (e.g., the bounding box coordinates) associated with the participant 514. In additional or alternative embodiments, target characteristic component 212 can identify a subregion of the image 252 (e.g., within the region of image 252) that includes facial features of the participant 514. In some embodiments, target characteristic component 212 can identify the subregion based on the outputs of the object detection model, as described above.

As illustrated by FIG. 5B, target characteristic component 212 can determine first bounding box data 516 for each participant 514 of image 252, where the first bounding box data represents a region of image 252 that depicts a respective participant 514. For example, bounding box data 516A can represent a region of image 252 that depicts participant 514A, bounding box data 516B data can represent a region of image 252 that depicts participant 514B, and bounding box data 516C can represent a region of image 252 that depicts participant 514C. Target characteristic component 212 can additionally or alternatively determine second bounding box data 518 for each participant 514, which represents a subregion of image 252 that depicts facial features of the respective participant. For example, bounding box data 518A can represent a subregion of image 252 that depicts facial features of participant 514A, bounding box data 518B data can represent a subregion of image 252 that depicts facial features of participant 514B, and bounding box data 516C can represent a subregion of image 252 that depicts facial features of participant 514C. It should be noted that, in some instances, participants 514 may obscure or be obscured by other participants 514 or objects of the environment. In such embodiments, bounding boxes identified for the participants 514 may overlap with bounding boxes for the obscuring or obscured participants 514 of objects.

Based on the bounding box data, target characteristic component 212 can determine the size of the participant 514 as depicted by image 252. For example, target characteristic component 214 can determine the width and the height of the bounding box associated with a respective participant 514 and can calculate an area of the bounding box space based on the determined width and height. In some embodiments, target characteristic component 212 can determine whether a difference of a size of two or more participants 514, as depicted by image 252, exceeds a difference threshold and, if so, determine the target focal length based on the difference. The relative sizes of the two or more participants 514 can be indicative of the positions of the participants, e.g. closer to or further from the camera component that collected the image, or can be used to determine the actual positions of the participants, as outlined below. For example, target characteristic component 212 can determine a difference in a size between participant 514A and participant 514C or between participant 514B and participant 514C, as depicted by image 252, exceeds a threshold difference and, if so, can determine the target focal length based on the difference. To determine the target focal length based on the difference, target characteristic component 214 can determine the real-world size of participant 514C and the position of participant 514C, as described below.

Target characteristic component 214 may determine the real-world size of participant 514C based on a known object size for another object of the shared meeting environment. For example, as described above, meeting feed component 210 may have determined the width of a table in the shared meeting room to be four feet wide (e.g., during the initialization period and/or the initial period of the virtual meeting 160). In such example, target characteristic component 214 can identify a region of image 252 that depicts the end of the table (e.g., based on object detection engine 402) and can determine dimensions the bounding box that encompasses the end of the table, as described above. Target characteristic component 212 can calculate or otherwise determine a size ratio between the width of the bounding box that encompasses the end of the table and the determined width of the real-world environment. For example, if the length of the bounding box encompassing the end of the table is 20 pixels, the size ratio can be 20 (pixels):4 (ft), or 5:1. Target characteristic component 214 can then determine the real-world size of participant 514C based on the size (e.g., length, width, area) of the bounding box for participant 514C and the size ratio. Target characteristic component 214 may determine the real-world size of participant 514C according to other techniques, in some embodiments. For example, media system 132 can include depth sensors (e.g., stereo cameras, LiDAR sensors, etc.) that measure a depth of an environment. Target characteristic component 214 may generate a mapping between coordinates of the region of image 252 indicated by the bounding box 516C for participant 514C to coordinates (e.g., Z-coordinates) captured by the depth sensors.

Target characteristic component 214 may determine a position of participant 514C by mapping a reference point (e.g., a center point) of the bounding box 516C to real-world coordinates for the shared meeting room. In some embodiments, target characteristic component 214 can apply a pinhole camera model to coordinates of bounding box 516C to estimate the real-world coordinates of the position of participant 514C in the shared meeting room. The pinhole camera model is indicated below

$$[ \begin{matrix}x \\ y\end{matrix} ] = \frac{f}{Z} [ \begin{matrix}X \\ Y\end{matrix} ] ⇒ X = \frac{x \cdot Z}{f} , Y = \frac{y \cdot Z}{f}$$

where f is the first focal length (e.g., in pixels), x,y represent coordinates of a reference point (e.g., a center point of image 252), Z is a depth or distance from the camera component to participant 514C, X,Y,Z represent real-world coordinates of participant 214C in the shared meeting room relative to the camera component. In some embodiments, target characteristic component 214 may determine the distance of the participant 514C from the camera component in accordance with previously described embodiments. In other or similar embodiments, target characteristic component 214 can estimate the distance of participant 514C from the camera component based on the real-world height of participant 514C (e.g., as determined based on the real-world size of participant 514C, as described above) and the height of the participant 514C as depicted by image 252, per the equation below

$$Z = \frac{f \cdot {H}_{r e a l}}{h}$$

where Z is the estimated depth or distance from the camera component to participant 514C, f is the first focal length (e.g., in pixels), Hᵣₑₐₗ is the real-world height of participant 514C, and h is the height of participant 514C as depicted by image 252.

Based on the real-world size and position of participant 514C, target characteristic component 212 can determine a target focal length for image 252. For example, target characteristic component 212 can determine a target focal length for image 252 based on the following equation

$${f}_{target} = \frac{{P}_{target} \cdot D}{S}$$

where f_{target} is the target focal length for image 252, P_{target} is the target size of participant 514C of the image, D is the distance from the camera component to participant 514C in the shared meeting room, and S is the real-world size of participant 514C. The target size of participant 514C can correspond to (match or approximately match) the size of participants 514A and/or 514B, as depicted by image 252.

Target characteristic component 212 can obtain the target characteristics 258 (e.g., the target focal length) for image 252 according to other techniques, in some embodiments. For example, an AI model 182 may be trained to predict an optimal focal length for an initial image based on characteristics (e.g., features, a location or position, etc.) of one or more objects depicted by the initial image. Target characteristic component 212 can provide image 252 as an input to such AI model 182 and obtain one or more outputs, which can include an indication of the optimal focal length. Such AI model 182 may be trained using historical data including one or more historical images and, for each historical image, a focal length of a camera or camera component that captured such historical image, in some embodiments.

As described above, target characteristic component 212 may determine a target focal length for image 252 based on a difference between a size of participants 514A and/or 515B and a size of participant 514C, as depicted by image 252. In other or similar embodiments, a participant of virtual meeting 160 (e.g., a participant 514 or another participant of virtual meeting 160) may request performance of a zoom operation with respect to a participant 514 or another object of the shared meeting environment. A zoom operation changes the apparent size of an object depicted by an image by scaling the image up (e.g., zooming in) or down (e.g., zooming out). Zooming in on a region of an image enlarges the features of objects of the region by stretching or interpolating pixels of such region to fill more space, making details appear larger and more prominent. Zooming out of a region of an image minimizes features of objects of the region by compressing objects of such region into fewer pixels. In some embodiments, a participant of virtual meeting 160 can provide a request for a zoom operation by engaging with one or more elements of UI 500. For example, tool bar 504 may include one or more additional UI elements (not shown) that enable a user to zoom into or zoom out of a region of image 252. In another example, a user may engage with UI elements (not shown) corresponding to sections of image 252 at region 502 (e.g., by double clicking the image 252, etc.) to zoom into or zoom out of such section of image 252. A participant may request the zoom operation according to other or additional techniques, in accordance with embodiments of the present disclosure.

In some embodiments, the request for the zoom operation can indicate a zoom factor, or a degree of enlargement or compression of the objects included in the region of image 252. In an illustrative example, the UI elements of region 202 and/or tool bar 504 can be associated with a particular degree of enlargement or compression. Target characteristic component 212 can determine the total degree of enlargement or compression based on the number of times a participant engages with the UI elements and/or an amount of time the participant engages with the UI elements, in some embodiments. In some embodiments, target characteristic component 212 can determine a target size of the region of image 252 depicting the object and can determine a target focal length of the image 252 based on the target size, as described above. In an illustrative example, a participant of virtual meeting 160 may request to zoom in on a region of image 252 that depicts participant 514C. The request can indicate that the total degree of enlargement of the region depicting participant 514C is 100% (e.g., doubling the size of participant 514C in the image). Target characteristic component can determine the target size of the region of image 252 depicting participant 514C by doubling the size of the image indicated by bounding box 516C and can determine the target focal length for the region of image 252 including participant 514C based on the target size, as described above.

In other or similar embodiments, the zoom operation may be initiated automatically based on an action of a participant 514 of the shared meeting room. For example, a host or other participant of virtual meeting 160 may request to enable a “featured speaker” functionality, where a participant that is detected to be providing an audio signal is to be featured via the virtual meeting UI 500. Upon detecting that a participant 514 located in the shared meeting room has started to provide an audio signal (e.g., has started speaking), platform 120 can initiate a zoom operation to focus the capture of image 252 with respect to such participant 514. The degree of enlargement of the speaking participant can be determined based on one or more settings or protocols associated with the “featured speaker” functionality (e.g., as defined by a developer or operator of platform 120 and/or a host of virtual meeting 160).

At block 306, processing logic provides the image and the target focal length as an input to an artificial intelligence (AI) model. Predictive component 214 can provide image 252 and the target focal length of target characteristics 258 as an input to AI model 182. In some embodiments, the AI model 182 can include a diffusion model. A diffusion model is a type of generative AI model that creates images (or other data) by learning to reverse a gradual noising process. The AI model 182 can transform an input image into a high-quality output image based on learned patterns and a given set of condition or parameters. Details regarding training AI model 182 are provided below with respect to FIGS. 6-7.

In some embodiments, predictive component 214 and/or meeting feed component 210 can provide image 252 as an input to a pre-processing engine 404, which can perform one or more pre-processing operations to enhance or otherwise improve a quality of image 252 prior to feeding the image 252 to AI model 182. The pre-processing operations can include, for example, resizing operations, normalization operations, color enhancement operations, denoising operations, and so forth. In some embodiments, pre-processing engine 404 can extract features from subregions of image 252 that depict facial features of participants 514 (e.g., as indicated by bounding boxes 518). Pre-processing engine 404 may extract the features of such subregions according to techniques, such as Scale-Invariant Feature Transform (SIFT) techniques, Histogram of Oriented Gradients (HOG) techniques, Oriented FAST and rotated BRIEF (ORB) techniques, convolutional neural network (CNN) techniques, and so forth. Predictive component 214 can provide the extracted features as an additional input to AI model 182. As will be seen below, the image generated by AI model 182 can maintain such extracted features of participants 514.

At block 308, processing logic obtains one or more outputs of the AI model. The one or more outputs include a generated image depicting the at least one participant in the environment as would be captured by another camera component having a second focal length corresponding to the target focal length. At block 310, processing logic provides the generated output image for presentation via one or more client devices associated with participants of the virtual meeting. A s illustrated by FIG. 5C, region 502 of UI 500 can include a generated image 260 depicting participants 514A, 514B, and 514C as would be captured by a camera component having the target focal length determined above. For example, as illustrated by FIG. 5C, the generated image 260 depicts participant 514C as the same (or approximately the same) size as participants 514A and 514B. Further, the ceiling of the shared meeting room, as depicted by generated image 260, is shortened based on the target focal length of the camera component. As described herein, UI 500 can include generated image 260 for presentation via a client device 102 of the shared meeting room and/or via client devices 102 of other participants of virtual meeting 160 (e.g., that are not present in the shared meeting room).

It should be noted that in some embodiments, the target focal length is determined once (e.g., during an initial period of virtual meeting 160) and applied to each video frame generated by the camera component, as described herein. In other or similar embodiments, the target focal length can be determined multiple times during the virtual meeting 160. For example, target characteristic component 212 can determine the target focal length periodically during the virtual meeting 160 (e.g., in accordance with a protocol or schedule associated with platform 120). In another example, target characteristic component 212 can determine the target focal length upon a detection of a new object in the shared meeting room environment and/or that an object of the shared meeting room environment has been removed. For instance, participants 514A and 514B may be present in the shared meeting room during an initial period of the virtual meeting 160. During such initial period, image improvement engine 154 may not generate improved images 260 based on the initial images 252 captured by the camera component (e.g., if the quality of the images 252 satisfy one or more quality criteria) and/or may generate improved images 260 based on the initial images 252 and a target focal length determined based on the position of participants 514A and 514C in the shared meeting room. During a subsequent time period, target characteristic component 212 may detect that participant 514C has joined the virtual meeting (e.g., and is sitting at a chair towards the back of the room). Based on such detection, target characteristic component 212 may determine an updated target focal length for the camera component based on the position of 514C, as described above, and apply such target focal length to images 252 (e.g., video frames) captured by the camera component through the remainder of the virtual meeting 160. In yet another example, upon detecting that participant 514C has left the shared meeting room, target characteristic component 212 may determine another updated target focal length (e.g., based on the position of participant 514A, 514B, based on the actual focal length of the camera component, etc.) and may apply the updated target focal length for subsequent images 252.

It should also be noted that although embodiments of the present disclosure are described with respect to images 252 depicting participants 514 in a shared meeting room, such embodiments can be applied for images 252 depicting participants in any environment. Further, additional or alternative information can be provided as an input to AI model 182. For example, image improvement engine 154 can obtain data or information pertaining to environmental conditions (e.g., lighting conditions, etc.) of an environment including participants of a virtual meeting 160 and provide such data or information as an input to AI model 182. The AI model 182 can generate image 260 based on such provided data or information, in some embodiments. Further, data or information described above and/or fed into AI model 182 (including but not limited to image 252 and/or target characteristics 258 described above) can be obtained based on other features or functionalities associated with virtual meeting 160 and/or platform 120. For example, positional data 256 may be determined in accordance with another feature or functionality associated with virtual meeting 160 and shared with image improvement engine 154.

As described above, image(s) 252 can be or otherwise include video frames of a sequence of video frames collected during a virtual meeting 160. Image improvement engine 154 can obtain the enhanced generated image 260 for an initial frame of the sequence, as described herein. Image improvement engine 154 can provide the generated image 260 as an additional input to AI model 182 for the subsequent frame, in some embodiments. Accordingly, the AI model 182 can apply or otherwise improve on the settings or parameters used for generating the image 260 for the initial frame when generating the image 260 for the subsequent frame.

FIG. 6 illustrates an example predictive system, in accordance with implementations of the present disclosure. As illustrated in FIG. 6 predictive system 180 can include a training set generator 612 (e.g., residing at server machine 610), a training engine 612, a validation engine 624, a selection 626, and/or a testing engine 628 (e.g., each residing at server machine 620), and/or a predictive component 652 (e.g., residing at server machine 650). Training set generator 612 may be capable of generating training data (e.g., a set of training inputs and a set of target outputs) to train one or more AI model 660 (e.g., AI model 182, etc.).

In some embodiments, one or more of AI model(s) 660 can include a general purpose model that is trained to perform a wide variety of tasks. In such embodiments, training set generator 612 can generate a training data set for training AI model 182 based on a corpus of textual data, audio data, video data, and so forth. The corpus can include a wide array of information gathered from numerous sources, including publicly available web pages (e.g., blogs, forums, news sites, academic papers, online encyclopedias, etc.), books and literature, social media, research papers, public datasets, and so forth. Training set generator 612 can extract features from data of the corpus and can transform the extracted features into a format that the AI model 182 can interpret. In some embodiments, training set generator 612 can perform one or more tokenization operations (e.g., to break down the textual data, audio data, video data, etc. into smaller units called tokens), one or more normalization operations (e.g., to convert the tokens into a common format and/or a format that can be handled by the AI model 182), one or more noise removal operations (e.g., to remove or filter out unwanted data or metadata), and/or one or more data formatting operations (e.g., to structure the tokens uniformly and indicate contextual windows between tokens indicating dependencies between tokens). In some embodiments, training set generator 612 can obtain annotation data for the tokens obtained based on the data of the corpus. Annotation data can include an indication of a classification associated with the token. In some embodiments, the annotation data can be provided by human annotators or according to other annotation techniques. Training set generator 612 can update the training data set to include the extracted features, the generated tokens, and/or the annotation data. As described below, training engine 622 can use the training data to perform the wide range of tasks.

In other or similar embodiments, one or more or AI model(s) 660 can be trained to perform specific tasks or operations, in accordance with embodiments described herein. For example, AI model 182 may additionally or alternatively be trained to generate enhanced images based on an input image and target characteristics or parameters of an input image. As described above, AI model 182 may be trained to generate an image (e.g., image 260) having a target focal length (e.g., a long focal length) based on an image generated by a camera component having an initial focal length (e.g., a short focal length). Training set generator 612 can generate a training data set for training such AI model 182 based on historical images, in some embodiments. For example, training set generator 612 can retrieve (e.g., from data store 110, from another database or corpus of system 100 or another system, etc.) a set of images depicting a common scene, where at least one image is captured by a camera component with a first focal length and another image is captured by a camera component with a second focal length. Training set generator 612 can generate a mapping between the image and the associated first focal length and the other image and the associated second focal length and include the generated mapping in the training data set. In additional or alternative embodiments, training set generator 612 can generate the training data set for training AI model 182 based on simulation data associated with a simulation of a camera capture process of a multi-dimensional (e.g., three-dimensional (3D)) simulated scene. Further details regarding generating the training data set based on such simulation data are provided below with respect to FIG. 7.

FIG. 7 is a block diagram of an example method 700 for training an AI model to generate an enhanced image, in accordance with implementations of the present disclosure. Method 700 can be performed by processing logic that can include hardware (circuitry, dedicated logic, etc.), software (e.g., instructions run on a processing device), or a combination thereof. In one implementation, some or all the operations of method 700 can be performed by one or more components of system 100 of FIG. 1 In some embodiments, some or all of the operations of method 700 can be performed by training set generator 612 or another component or engine of system 100.

At block 702, processing logic generates a multi-dimensional representation of an object in an environment. In some embodiments, processing logic can obtain a model file associated with a simulated scene of the object in the environment. In some embodiments, the training set generator 612 can obtain a media item (e.g., a video feed, etc.) representing the object in a real-world environment. For example, processing logic can obtain a video feed of a prior virtual meeting 160 conducted via platform 120 or another platform. Processing logic can provide the video feed as an input to a simulation engine that is configured to generate a model file pertaining to a 3D reconstruction of the scene of a given media item. The simulation engine can include or otherwise correspond to a deep-learning based system that can generate 3D models of environments using a single moving camera. The simulation engine can generate the 3D model of the prior virtual meeting 160 by performing operations such as pose estimation of objects detected in the video feed, depth estimation and/or feature matching for the detected objects, volumetric reconstruction of the surface geometry of the 3D scene, and so forth. The simulation engine can provide the model file that, when executed by a rendering engine (e.g., of system 100) generates a rendering of the 3D model of the prior virtual meeting 160. In other or similar embodiments, processing logic can obtain a model file for a 3D model or representation of another scene (e.g., other than a virtual meeting) including one or more objects. The model file can correspond to a 3D scene of a real-world environment, a gaming environment, and so forth. Processing logic can obtain such model file from a developer or engineer of system 100 and/or from a database or corpus that includes such types of model files.

Upon obtaining a model file, as described above, processing logic can provide the model file to a rendering engine to generate the rendering of the 3D model (e.g., of the virtual meeting, of the other scene, etc.). In some embodiments, a user (e.g., developer or operator) of system 100 can provide (e.g., via a client device 102 or via another device of system 100) an indication of one or more parameters for the rendering of the scene, the parameters including a focal length of a camera capturing the simulated view of the 3D model. In an illustrative example, the user can provide one or more parameters pertaining to a short focal length of the camera capturing the simulated view of the 3D model. Accordingly, the generated rendering of the 3D model, as presented to the user, can reflect characteristics of images captured by camera components having a short focal length.

At block 704, processing logic extracts, from the multi-dimensional representation, one or more visual features associated with the object in the environment. Processing logic can perform object detection operations to detect different types of objects included in scene represented by the 3D model and can extract or otherwise determine features associated with such objects. For example, processing logic can extract poses of such objects, visual features pertaining to such objects, actions or motions pertaining to such objects, and so forth. In some embodiments, processing logic can extract the visual features based on one or more engines of system 100 (or of another system). For example, processing logic can provide the model file and/or the rendering of the scene of the model file as an input to a pose estimation engine, which is configured to detect a pose or position of one or more portions of an object in a 3D space. In another example, processing logic can provide the model file and/or the rendering of the scene of the model file as an input to an appearance feature engine (e.g., including or based on a CNN) configured to extract color information, texture information, shape information, etc. of one or more objects included in the scene. In yet another example, processing logic can provide the model file and/or the rendering of the scene as an input to a scene understanding engine that is configured to detect objects of the 3D model and predict or otherwise estimate actions or motions of the scene involving the objects. It should be noted that other types of engines or models can be used to extract visual features associated with the objects in the environment of the 3D model.

At block 706, processing logic generates an enhanced multi-dimensional representation of the object in the environment. The enhanced multi-dimensional representation of the object maintains the extracted features of block 704. In some embodiments, the user can provide an indication of a target focal length of a camera capturing a simulated view of the 3D model. Processing logic can provide the target focal length to the simulation engine and the simulation engine can update the model file based on the target focal length. Processing logic can provide the model file to the rendering engine, which can generate an updated rendering of the 3D model. The updated rendering can have characteristics of a camera component having the target focal length, in some embodiments. In additional or alternative embodiments, processing logic can also provide an indication of the extracted features to the simulation engine, and the simulation engine can update the model file such that the updated 3D model can maintain the extracted features of the initial rendering of the 3D model.

At block 708, processing logic generates training data including a training input and a target output. The training input can include first image data including the multi-dimensional representation of the object in the environment and one or more first camera characteristics associated with the first image. The one or more first camera characteristics can include or otherwise correspond to the short focal length of the camera that captured the simulated view (e.g., represented by the first image data) of the initial 3D model. The target output can also include second image data including the enhanced multi-dimensional representation of the object in the environment and one or more second camera characteristics associated with the second image data. The one or more second camera characteristics can include or otherwise correspond to the target focal length (e.g., the long focal length) of the camera that captured the simulated view (e.g., represented by the second image data) of the enhanced 3D model. At block 710, processing logic can update a training data set to include the generated training data.

In some embodiments, the training data set of method 700 can include data collected from simulated scenes of different environments and/or different objects in environments. For example, the training data set can include first training data generated based on a 3D reconstruction of a prior virtual meeting 160 of platform 120 (or of another platform) and a second training data generated based on a 3D reconstruction and/or a synthesized 3D model of another environment (e.g., a park, an office hallway, etc.).

Training engine 622 can train an AI model 660 using the training data from training set generator 612, as described above. The model 660 can refer to the model artifact that is created by the training engine 622 using the training data that includes training inputs and/or corresponding target outputs (correct answers for respective training inputs). The training engine 622 can find patterns in the training data that map the training input to the target output (the answer to be predicted), and provide the model 660 that captures these patterns. The model 660 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like.

In some embodiments, training engine 622 can first pre-train the AI model 660 on a corpus of text or images (e.g., generated by or accessible to training set generator 612 and/or training engine 622) to create a foundational model, and afterwards fine-tuned on more data pertaining to a particular set of tasks to create a more task-specific, or targeted, model. The foundational model can first be pre-trained using a corpus of text that can include text context in the public domain, licensed content, and/or proprietary content. Such a pre-training can be used by the model to learn broad language elements including general sentence structure, common phrases, vocabulary, natural language structure, and any other elements commonly associated with natural language in a large corpus of text. In some embodiments, this first, foundational model can be trained using self-supervision, or unsupervised training on such datasets.

In some embodiments, the AI model 660 can then be further trained and/or fine-tuned on organizational data, including proprietary organizational data. The AI model 660 can also be further trained and/or fine-tuned on organizational data associated with a virtual meeting 160 and/or other documents, including proprietary organizational data associated with a virtual meeting 160 and/or other documents.

In some embodiments, the second portion of training, including fine-tuning, may be unsupervised, supervised, reinforced, or any other type of training. In some embodiments, this second portion of training may include some elements of supervision, including learning techniques incorporating human or machine-generated feedback, undergoing training according to a set of guidelines, or training on a previously labeled set of data, etc. In a non-limiting example associated with reinforcement learning, the outputs of the AI model 660 while training may be ranked by a user, according to a variety of factors, including accuracy, helpfulness, veracity, acceptability, or any other metric useful in the fine-tuning portion of training. In this manner, the AI model 660 can learn to favor these and any other factors relevant to users within an organization, or associated with a virtual meeting, when generating a response. In such a way, a foundational model can be further trained to perform within a virtual meeting, and provide useful information, as well as help to accomplish useful tasks associated with the virtual meeting.

In some embodiments, the AI model 660 may include one or more pre-trained models, or fine-tuned models. In a non-limiting example, in some embodiments, the goal of the “fine-tuning” may be accomplished with a second, or third, or any number of additional models. For example, the outputs of the pre-trained model may be input into a second AI model that has been trained in a similar manner as the “fine-tuned” portion of training above. In such a way, two more AI models may accomplish work similar to one model that has been pre-trained, and then fine-tuned.

In one embodiment, the AI model 660 may be one or more of decision trees, random forests, support vector machines, or other types of machine learning models. In one embodiment, the AI model 660 may be one or more artificial neural networks (also referred to simply as a neural network). The artificial neural network may be, for example, a convolutional neural network (CNN) or a deep neural network. In one embodiment, processing logic performs supervised machine learning to train the neural network.

Artificial neural networks generally include a feature representation component with a classifier or regression layers that map features to a target output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). The neural network may be a deep network with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

In some embodiments, the AI model 660 may be one or more recurrent neural networks (RNNs). An RNN is a type of neural network that includes a memory to enable the neural network to capture temporal dependencies. An RNN is able to learn input-output mappings that depend on both a current input and past inputs. The RNN will address past and future measurements and make predictions based on this continuous measurement information. One type of RNN that may be used is a long short term memory (LSTM) neural network.

As indicated above, the AI model 660 may be one or more generative AI models, allowing for the generation of new and original content. The generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including recurrent neural networks (RNNs), convolutional neural networks (CNNs), or transformer networks.

Validation engine 624 may be capable of validating a trained model 660 using a corresponding set of features of a validation set from training set generator 612. The validation engine 624 may determine an accuracy of each of the trained models 660 based on the corresponding sets of features of the validation set. The validation engine 624 may discard a trained model 660 that has an accuracy that does not meet a threshold accuracy. In some embodiments, the selection engine 626 may be capable of selecting a trained model 660 that has an accuracy that meets a threshold accuracy. In some embodiments, the selection engine 626 may be capable of selecting the trained model 660 that has the highest accuracy of the trained models 660.

The testing engine 686 may be capable of testing a trained model 660 using a corresponding set of features of a testing set from training set generator 612. For example, a first trained model 660 that was trained using a first set of features of the training set may be tested using the first set of features of the testing set. The testing engine 628 may determine a trained model 660 that has the highest accuracy of all of the trained machine learning models based on the testing sets.

As described herein, predictive component 216 of server 650 (and/or of image improvement engine 154) may be configured to feed data as input to model 660 and obtain one or more outputs. In some embodiments, predictive component 652 can include or be associated with image improvement engine 154.

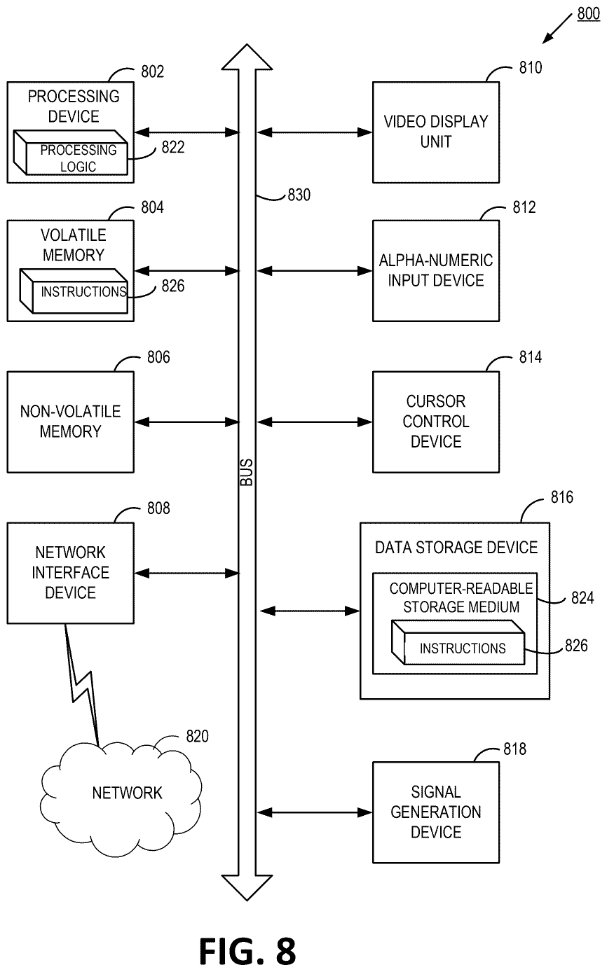

FIG. 8 is a block diagram illustrating an example computer system 800, in accordance with implementations of the present disclosure. The computer system 800 can correspond to platform 120 and/or client devices 102A-N, described with respect to FIG. 1 Computer system 800 can operate in the capacity of a server or an endpoint machine in endpoint-server network environment, or as a peer machine in a peer-to-peer (or distributed) network environment. The machine can be a television, a personal computer (PC), a tablet PC, a set-top box (ST B), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processing device (processor) 802, a volatile memory 804 (e.g., read-only memory (ROM), flash memory, dynamic random access memory (DRAM) such as synchronous DRAM (SDRAM), double data rate (DDR SDRAM), or DRAM (RDRAM), etc.), a non-volatile memory 806 (e.g., flash memory, static random access memory (SRAM), etc.), and a data storage device 816, which communicate with each other via a bus 830.

Processor (processing device) 802 represents one or more general-purpose processing devices such as a microprocessor, central processing unit, or the like. More particularly, the processor 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 802 can also be one or more special-purpose processing devices such as an application specific integrated circuit (ASIC), a field programmable gate array (FPGA), a digital signal processor (DSP), network processor, or the like. The processor 802 is configured to execute processing logic 822 for performing the operations discussed herein.

The computer system 800 can further include a network interface device 808. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 818 (e.g., a speaker).

The data storage device 816 can include a non-transitory machine-readable storage medium 824 (also computer-readable storage medium) on which is stored one or more sets of instructions 826 embodying any one or more of the methodologies or functions described herein. The instructions can also reside, completely or at least partially, within the volatile memory 804 and/or within the processor 802 during execution thereof by the computer system 800, the volatile memory 804 and the processor 802 also constituting machine-readable storage media. The instructions can further be transmitted or received over a network 820 via the network interface device 808.

In one implementation, the instructions 826 include instructions for providing fine-grained version histories of electronic documents at a platform. While the computer-readable storage medium 824 (machine-readable storage medium) is shown in an example implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include the collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
obtaining, during a virtual meeting, an image depicting at least one participant of a plurality of participants of the virtual meeting in an environment, wherein the image is captured by a camera component having a first focal length;
determining, during the virtual meeting, a target focal length for the image based on a position of the at least one participant in the environment;
providing, during the virtual meeting, the image and the target focal length as an input to an artificial intelligence (AI) model;
obtaining, during the virtual meeting, one or more outputs of the AI model, the one or more outputs comprising a generated image depicting the at least one participant in the environment as would be captured by another camera component having a second focal length corresponding to the target focal length; and
providing, during the virtual meeting, the generated image for presentation via one or more client devices associated with the plurality of participants.

2. The method of claim 1, further comprising:
determining that the position of the at least one participant in the environment has changed;
determining an updated target focal length for the image based on the changed position;
providing an additional image depicting the at least one participant in the changed position and the updated target focal length as an additional input to the AI model;
obtaining one or more additional outputs of the AI model, the one or more additional outputs comprising an additional generated image depicting the at least one participant in the environment as would be captured by the other camera component having a third focal length corresponding to the updated target focal length; and
providing, during the virtual meeting, the additional generated image for presentation via the one or more client devices.

3. The method of claim 1, further comprising:
receiving a request for performance of a zoom operation to modify a perspective of the at least one participant from a first zoom factor to a second zoom factor with respect to a field of view of the camera component, wherein the target focal length is further determined based on the first zoom factor and the second zoom factor.

4. The method of claim 3, wherein the request for performance of the zoom operation is received responsive to at least one of:
a user interaction with one or more user interface (UI) elements of a meeting UI at the one or more client devices, or
a detection of an audio signal at a region of the environment including the at least one participant.

5. The method of claim 1, further comprising:
obtaining feature data representing one or more features associated with a region of the image that depicts the at least one participant; and
providing the feature data as an additional input to the AI model, wherein the generated image depicting the at least one participant comprises the one or more features represented by the provided feature data.

6. The method of claim 5, wherein obtaining the feature data comprises:
performing one or more bounding box operations with respect to the image, wherein an output of the one or more bounding box operations comprises bounding box data representing the region of the image that depicts the at least one participant; and
extracting the one or more features from the region of the image represented by the bounding box data.

7. The method of claim 5, wherein obtaining the feature data comprises:
receiving the feature data from a component of a cloud computing platform associated with one or more additional functionalities with respect to the virtual meeting.

8. The method of claim 1, further comprising:
receiving at least a portion of the AI model from one or more computing devices associated with a cloud computing platform; and
storing the at least the portion of the AI model at a memory of a local computing device associated with the environment,
wherein the image and the target focal length are provided as the input to the AI model stored at the memory of the local computing device.

9. The method of claim 1, wherein the image comprises an initial video frame of a sequence of video frames captured by the camera component during the virtual meeting, and wherein the method further comprises:
obtaining a subsequent video frame of the sequence of video frames, the subsequent video frame depicting the at least one participant in the environment;
providing the subsequent video frame, the target focal length, and the generated image associated with the initial video frame as an additional input to the AI model;
obtaining one or more additional outputs of the AI model, the one or more additional outputs comprising an additional generated image depicting the at least one participant as captured by the other camera component having the second focal length corresponding to the target focal length and in view of the generated image associated with the initial video frame; and
providing, during the virtual meeting, the generated additional output image for presentation via the one or more client devices.

10. The method of claim 1, wherein the AI model is a diffusion model.

11. The method of claim 1, wherein the AI model is trained using a training data set comprising:
a training input comprising an image depicting a multi-dimensional representation of an environment and an indication of a training focal length associated with the image, and
a target output comprising an enhanced image depicting the multi-dimensional representation of the environment and an indication of a training target focal length associated with the enhanced image.

12. A system comprising:
a memory; and
a processing device, coupled to the memory, configured to perform operations comprising:
obtaining, during a virtual meeting, an image depicting at least one participant of a plurality of participants of the virtual meeting in an environment, wherein the image is captured by a camera component having a first focal length;
determining, during the virtual meeting, a target focal length for the image based on a position of the at least one participant in the environment;
providing, during the virtual meeting, the image and the target focal length as an input to an artificial intelligence (AI) model;
obtaining, during the virtual meeting, one or more outputs of the AI model, the one or more outputs comprising a generated image depicting the at least one participant in the environment as would be captured by another camera component having a second focal length corresponding to the target focal length; and
providing, during the virtual meeting, the generated image for presentation via one or more client devices associated with the plurality of participants.

13. The system of claim 12, wherein the operations further comprise:
determining that the position of the at least one participant in the environment has changed;
determining an updated target focal length for the image based on the changed position;
providing an additional image depicting the at least one participant in the changed position and the updated target focal length as an additional input to the AI model;
obtaining one or more additional outputs of the AI model, the one or more additional outputs comprising an additional generated image depicting the at least one participant in the environment as would be captured by the other camera component having a third focal length corresponding to the updated target focal length; and
providing, during the virtual meeting, the additional generated image for presentation via the one or more client devices.

14. The system of claim 12, wherein the operations further comprise:
receiving a request for performance of a zoom operation to modify a perspective of the at least one participant from a first zoom factor to a second zoom factor with respect to a field of view of the camera component, wherein the target focal length is further determined based on the first zoom factor and the second zoom factor.

15. The system of claim 14, wherein the request for performance of the zoom operation is received responsive to at least one of:
a user interaction with one or more user interface (UI) elements of a meeting UI at the one or more client devices, or
a detection of an audio signal at a region of the environment including the at least one participant.

16. The system of claim 12, wherein the operations further comprise:
obtaining feature data representing one or more features associated with a region of the image that depicts the at least one participant; and
providing the feature data as an additional input to the AI model, wherein the generated image depicting the at least one participant comprises the one or more features represented by the provided feature data.

17. The system of claim 16, wherein obtaining the feature data comprises:
performing one or more bounding box operations with respect to the image, wherein an output of the one or more bounding box operations comprises bounding box data representing the region of the image that depicts the at least one participant; and
extracting the one or more features from the region of the image represented by the bounding box data.

18. A non-transitory computer readable storage medium comprising instructions that, when executed by a processing device, cause the processing device to perform operations comprising:
obtaining, during a virtual meeting, an image depicting at least one participantof a plurality of participants of the virtual meeting in an environment, wherein the image is captured by a camera component having a first focal length;
determining, during the virtual meeting, a target focal length for the image based on a position of the at least one participant in the environment;
providing, during the virtual meeting, the image and the target focal length as an input to an artificial intelligence (AI) model;
obtaining, during the virtual meeting, one or more outputs of the AI model, the one or more outputs comprising a generated image depicting the at least one participant in the environment as would be captured by another camera component having a second focal length corresponding to the target focal length; and
providing, during the virtual meeting, the generated image for presentation via one or more client devices associated with the plurality of participants.

19. The non-transitory computer readable storage medium of claim 18, wherein the operations further comprise:
determining that the position of the at least one participant in the environment has changed;
determining an updated target focal length for the image based on the changed position;
providing an additional image depicting the at least one participant in the changed position and the updated target focal length as an additional input to the AI model;
obtaining one or more additional outputs of the AI model, the one or more additional outputs comprising an additional generated image depicting the at least one participant in the environment as would be captured by the other camera component having a third focal length corresponding to the updated target focal length; and
providing, during the virtual meeting, the additional generated image for presentation via the one or more client devices.

20. The non-transitory computer readable storage medium of claim 18, wherein the operations further comprise:
receiving a request for performance of a zoom operation to modify a perspective of the at least one participant from a first zoom factor to a second zoom factor with respect to a field of view of the camera component, wherein the target focal length is further determined based on the first zoom factor and the second zoom factor.
